(19) United States
(12) Patent Application Publication
(10) Pub. No.: US 2007/0015079 A1
(43) Pub. Date: Jan. 18, 2007

(54) Laser induced thermal imaging business models and methods

(76) Inventors: Martin B. Wolk, Woodbury, MN (US); Rick L. Neby, Plymouth, MN (US); William A. Tolbert, Woodbury, MN (US); Bradley D. Zinke, Woodbury, MN (US); Thomas A. Isberg, Minneapolis, MN (US); James M. Nelson, Lino Lakes, MN (US)

Correspondence Address: 3M INNOVATIVE PROPERTIES COMPANY, PO BOX 33427, ST. PAUL, MN, 55133-3427, US

(21) Appl. No.: 11/183,404

(22) Filed: Jul. 18, 2005

(51) Int. Cl. G03C 8/00

(52) U.S. Cl. 430/199

(57) ABSTRACT

Various processes and models are provided for laser induced thermal imaging for use in manufacturing display elements. The processes and models set forth criteria for manufacture and delivery of donor film for use in laser induced thermal imaging, and licensing of related information for an imaging process using the donor film.

### FIELD OF INVENTION

The present invention relates to business models and methods to implement laser induced thermal imaging for manufacture of display elements.

### BACKGROUND

Laser induced thermal imaging (LITI) is a digital printing technology based on the thermal mass transfer of material from a donor film to a receptor surface. For organic light emitting displays (OLEDs), the donor film is coated with an ultrathin layer of red, green, or blue emitting material, one material at a time. An imaging process for patterning is accomplished by laminating the coated donor film to an active matrix OLED backplane. After an alignment step, a laser is used to expose the laminated assembly in an imaging process. Exposed regions of material are released from the donor film and adhered to the receptor. The process is repeated three times for the red, green, and blue materials.

The process to coat and image the donor film requires an ultraclean environment. The OLED materials, or other materials to be transferred, are typically very sensitive to oxygen, moisture, and other contaminants such as dust. Those contaminants can severely degrade the performance and lifetime of an OLED device, if they are encapsulated in the OLED device during the LITI process.

These considerations can be of importance when one entity does not manufacture the donor film and perform the entire LITI process of coating and imaging the film. For example, certain companies that have the technology to manufacture donor film may not necessarily be in the business of making OLEDs or other displays using the LITI process. Other companies that are in the business of making displays using the LITI process may not necessarily have the technology to manufacture donor film or they may require rights to use donor film in the LITI process. Also, the LITI process can involve many different constructions or types of donor film depending upon, for example, the materials to be coated and the imaging conditions. Therefore, a donor manufacturer in many cases needs information from a display manufacture in order to make the best donor film for the desired use by the display manufacturer.

There are several existing businesses based on laser thermal printing. Most of those business models are designed for use in the graphic arts market as digital halftone color proofing systems, and they hence do not address the particular considerations required by a LITI process. In particular, existing companies and business models typically supply an imagesetter and precoated media without tailoring the imagesetter or media to any particular customer. The following are examples of these companies and business models.

Latran Technologies (Bedford, Mass., US) is a company that supplies digital halftone laser color proofing systems to the graphic art and printing markets. The systems are based upon laser ablation technology (LAT) and utilize Latran's dry tech thermal imagesetting film. It appears that Latran's customers can purchase one of four laser imagesetters as well as the imagesetting film. The film is precoated with a pigment transfer layer.

Kodak (Rochester, N.Y., US) has had at least three digital halftone laser color proofing systems on the market, known as LASER MATCHPRINT, KODAK APPROVAL, and Creo SPECTRUM. The LASER MATCHPRINT product is a laser thermal transfer system that includes hardware, software, and media. The media is sold as precoated transfer films with a pigmented transfer layer. The Kodak Creo imagers may be used with a variety of media that has been qualified by Creo. For example, laser thermal transfer media from the following companies are identified as qualified media for use in Creo's SPECTRUM laser imagesetter: DuPont (Wilmington, Del., US), Fuji Photo Film U.S.A. (Valhalla, N.Y., US), Kodak Polychrome Graphics (part of Kodak's Graphic Communications Group), and Latran. Creo also sells digital media optimized for use in their imagesetters.

Fuji Photo Film U.S.A. sells both an digital halftone laser color proofing system as well as thermal donor media. The media is most likely precoated with a pigmented transfer layer.

International Inaging Materials (iimak) (Amherst, N.Y., US) is a manufacturer of thermal transfer film for conventional (e.g., non-laser) thermal transfer printing. Although iimak does not produce media for laser thermal transfer systems, the company is an example of an existing business in transfer media, which is supplied as precoated rolls of film.

### SUMMARY OF INVENTION

A method for laser induced thermal imaging using associated instructions includes the following steps. A first entity receives donor film comprising a substrate and a light-to-heat conversion layer on the substrate. The donor film is manufactured by a second entity and delivered to the first entity. Instructions are received indicating how to coat and transfer materials using the donor film according to an imaging process. The materials are coated as a transfer layer on the light-to-heat conversion layer of the donor film and, according to the instructions, the imaging process is performed for manufacture of a display element.

A method for laser induced thermal imaging using an associated compatibility file includes the following steps. A first entity receives donor film comprising a substrate and a light-to-heat conversion layer on the substrate. The donor film is manufactured by a second entity and delivered to the first entity. A compatibility file is received and it certifies the compatibility of particular materials to be transferred with particular constructions of the donor film for an imaging process. According to the compatibility file, materials and a particular construction of the donor film are selected. The selected materials are coated as a transfer layer on the selected construction of the donor film, and the imaging process is performed for the manufacture of a display element.

A method for laser induced thermal imaging using film frames includes the following steps. A first entity receives donor film installed in film frames by a second entity or a third party; the donor film comprises a substrate and a light-to-heat conversion layer on the substrate. A second entity manufactures the donor film, installs the donor film in the film frames, and delivers to the first entity the film frames with the installed donor film. A material is applied to the donor film in the film frames, and an imaging process is performed for the donor film while in the film frames for the manufacture of a display element. Use of the film frames is licensed for the imaging process with the installed donor film and a fee is provided for the licensing.

A method for laser induced thermal imaging by licensing the use of donor film includes the following steps. A first entity receives donor film comprising a substrate and a light-to-heat conversion layer on the substrate. The donor film is manufactured by a second entity and delivered to the first entity. A material is coated on the donor film and an imaging process of the coated donor film is performed for use in manufacturing a display element. The second entity licenses the use the donor film for the imaging process and receives a credit for returning the imaged donor film.

A method for laser induced thermal imaging using a donor film stock roll good includes the following steps. A first entity receives donor film installed in film frames; the donor film comprises a substrate and a light-to-heat conversion layer on the substrate. A second entity manufactures the donor film as a stock roll good, provides within the stock roll good imaging zones intended for an imaging process of the donor film, and delivers to the first entity the stock roll good donor film. A material is applied to the donor film based upon the imaging zones, and an imaging process is performed for the donor film while in the film frames for use in manufacturing a display element.

A method for laser induced thermal imaging using a continuous process includes the following steps. Donor film is manufactured, coated with a material, and imaged with the material for use in manufacturing a display element. The manufacturing, coating, and imaging steps occur in a facility as a single continuous process.

A computerized method for providing a central clearinghouse for laser induced thermal imaging includes the following steps. A central repository electronically stores an identification of materials for imaging, an identification of constructions of donor film, and compatibility data providing an indication of which of the materials are compatible for an imaging process with which of the donor film constructions. An order for donor film is received from an entity. Based upon the order and the compatibility data, at least one of the materials and donor film constructions are selected. Delivery of the selected donor film to the entity is electronically arranged, and a message is electronically sent to the entity providing an indication of the selected materials.

As used herein, the following terms and phrases have the following meaning.

The term “display backplane” refers to substrate comprising an array of pixels and subpixels, row and column electrodes, and subpixel control circuitry that is incorporated into an electronic display and functions to control the relative appearance (e.g., brightness) of each subpixel in each temporal frame of a video or data picture.

The term “display element” refers to any element, component, or sub-component of a display device, whether visible to a user or not.

The term “display panel entity” refers to an entity that uses donor film to perform, or have performed, an imaging process to make a display element.

The term “donor entity” refers to an entity that manufactures, or has made, donor film and can provide it to another entity.

The term “donor film” refers to a complete assembly for LITI including, for example, a support film, a heating layer, an optional interlayer (or interlayers), and a transfer layer.

The term “entity” as used, for example, in the terms donor entity, display panel entity, and imager entity can refer to a separate legal entity, such as a corporation, or can refer to separate portions of the same legal entity, such as different divisions, groups, or subsidiaries of the same corporation.

The term “film frame” refers to a rigid support designed to tension sheeted stock roll or donor film.

The term “imager” refers to a precision laser exposure platform designed to enable transfer of material from a donor film to a receptor surface, for example a display backplane.

The term “imager entity” refers to an entity that manufactures, or has made, an imager for use with a LITI process.

The term “imaging process” refers to imaging of donor film to transfer a material from the donor film to a receptor as part of a LITI process.

The term “LITI” refers to laser induced thermal imaging.

The term “stock roll” refers to an incomplete assembly for LITI including, for example, a support film and a heating layer, but not a transfer layer.

The term “vendor” refers to an entity (see the definition of the term “entity”).

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram illustrating an example of LITI donor film;

FIG. 2 is a diagram illustrating a business model for providing donor film with instructions for a LITI process;

FIG. 3 is a flow chart of a method for providing donor film with instructions for a LITI process;

FIG. 4 is a diagram illustrating a business model for providing donor film with a compatibility file for a LITI process;

FIG. 5 is a flow chart of a method for providing donor film with a compatibility file for a LITI process;

FIG. 6 is a diagram illustrating a business model for providing donor film in film frames for a LITI process;

FIG. 7 is a diagram illustrating donor film mounted in a film frame;

FIG. 8 is a diagram illustrating a cassette of film frames having donor film mounted in them;

FIG. 9 is a flow chart of a method for providing donor film in film frames for a LITI process;

FIG. 10 is a diagram illustrating a business model for providing and licensing the use of donor film for a LITI process;

FIG. 11 is a flow chart of a method for providing and licensing the use of donor film for a LITI process;

FIG. 12 is a diagram illustrating a business model for providing donor film as a stock roll good with imaging zones for a LITI process;

FIG. 13 is a diagram illustrating donor film with imaging zones;

FIG. 14 is a flow chart of a method for providing donor film as a stock roll good for a LITI process;

FIG. 15 is a diagram illustrating a business model for manufacturing donor film and imaging it using LITI to make a display element in a facility in a single continuous process;

FIG. 16 is a diagram illustrating a system for providing a central repository as a clearinghouse to arrange for the delivery of donor film for a LITI process; and

FIG. 17 is a flow chart of a method for providing a central repository as a clearinghouse to arrange for the delivery of donor film for a LITI process.

### DETAILED DESCRIPTION

Overview

LITI is a dry, digital, high resolution patterning method that has been developed for printing materials for flat panel display or other applications. The method is particularly suited for transferring of ultra-thin materials using the donor when those materials cannot be precoated. The materials can include OLED materials or any other materials to be transferred for any purposes. In certain embodiments, the LITI method involves the following steps performed in sequential order:

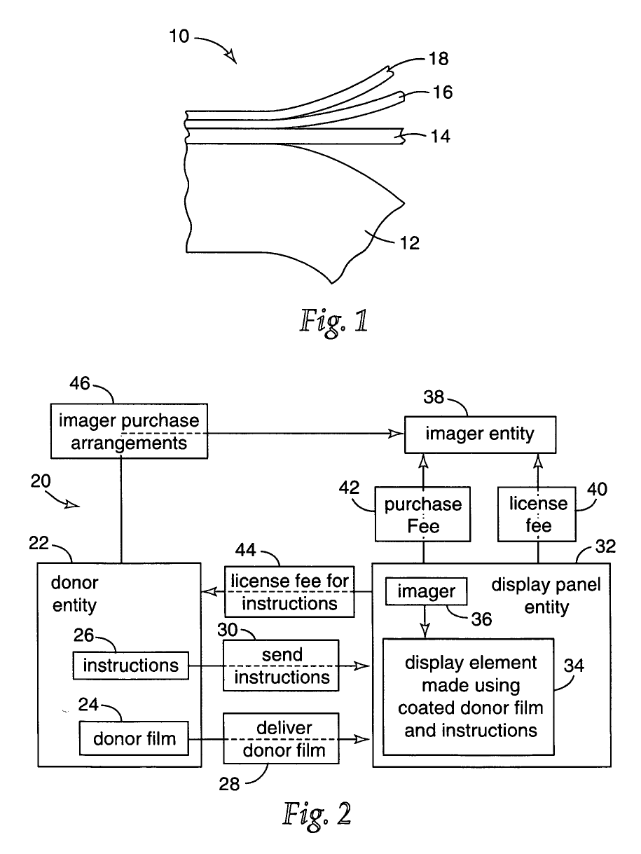

1. Manufacture of a donor stock roll comprising a substrate and a light to heat conversion (LTHC) layer by a series of industrial coating techniques. As shown in FIG. 1, donor stock film 10 includes a light transparent substrate 12 having deposited thereon, in the following order, a light-to-heat conversion (LTHC) layer 14 and an optional heat stable interlayer 16. The substrate 12 is typically a polyester film, for example, poly(ethylene terephthalate) or poly(ethylene naphthalate). However, any film that has appropriate optical properties and sufficient mechanical stability can be used.

2. Deposition of a transfer layer 18 (e.g., a 30 nm thick film of OLED emissive material) on the donor stock roll in order to form the completed donor film.

3. Lamination of the completed donor film to a display substrate.

4. Exposure of the donor film/substrate laminate with a high power, high positional accuracy laser system.

5. Removal and optional disposal of the expended donor film.

6. Optionally, the recovery, purification, and recycling of unused transfer layer material (up to 85% of the material as originally deposited in certain embodiments).

Embodiments of the LITI technology have been developed for patterning a variety of materials on display substrates. For example, LITI can be used in patterning color filters, color conversion filters, black matrix materials, OLED materials, phosphors, polarizers, and other materials or technology. The role of the donor film manufacturer (donor entity) has typically been to demonstrate the technology, design the laser exposure system, develop specific and optimized donor films, and certify the transferability of the material(s) as specified by the flat panel display (FPD) manufacturer.

For multiple reasons, it can be preferable for the donor film manufacturer to supply the donor stock material (step 1 above) to the FPD manufacturer along with related technology to allow the FPD manufacture to coat and image the donor film in a LITI process. This allows the FPD manufacturer to deposit the critical transfer layer (step 2 above) in an ultraclean semiconductor fabrication environment, avoids the issue of the stability of ultrathin layers during packaging and shipping, and minimizes the time between transfer layer coating and imaging.

Because the finished product for a LITI process, the donor film with a transfer layer, is completed at the FPD site rather than at the donor film manufacturer's site and used in a LITI patterning process, there are unique and advantageous business models associated with the sale of the unfinished donor film and the licensing of the process.

An example of a LITI process is described in detail in Wolk et al., “Laser Thermal Patterning of OLED Materials,” Organic Light-Emitting Materials and Devices VII, Proceedings of SPIE Vol. 5519 (SPIE, Bellingham, Wash. 2004), which is incorporated herein by reference as if fully set forth.

Process Models

Tables 1-4 provide examples of process models for performing LITI with the steps being performed in the order recited. The process models shown in Tables 1-4 can be embodied, for example, in the form of legal relationships among the relevant entities, and that relationship can be monitored and tracked through a computerized process.

TABLE 1
Process Model A

| Step | Description |
|---|---|
| 1 | Donor film manufacturer (donor entity) develops LITI patterning |
| | method for imager and donor film. |
| 2 | Donor film manufacturer produces stock roll. |
| 3 | Donor film manufacturer provides imager specifications to |
| | vendor A. |
| 4 | Vendor A sells imager to customer B (display panel entity). |
| 5 | Customer B purchases stock roll from donor film manufacturer. |
| 6 | Customer B deposits transfer layer on donor film manufacturer |
| | stock roll. |
| 7 | Customer B patterns donor film on display backplane according to |
| | donor film manufacturer methods. |
| 8 | Customer B sells LITI patterned display. |

TABLE 2
Process Model B

| Step | Description |
|---|---|
| 1 | Donor film manufacturer (donor entity) develops LITI patterning |
| | method for imager and donor film. |
| 2 | Donor film manufacturer produces stock roll. |
| 3 | Donor film manufacturer sheets, inspects, and mounts stock |
| | roll into film frames. |
| 4 | Donor film manufacturer provides imager specifications to |
| | vendor A. |
| 5 | Vendor A sells imager to customer B (display panel entity). |
| 6 | Customer B purchases stock roll frames from donor film |
| | manufacturer. |
| 7 | Customer B deposits transfer layer on donor film manufacturer |
| | stock roll frames. |
| 8 | Customer B patterns donor film on display backplane according to |
| | donor film manufacturer methods. |
| 9 | Customer B returns spent film frames to donor film manufacturer |
| | for a credit. |
| 10 | Customer B sells LITI patterned display. |

TABLE 3
Process Model C

| Step | Description |
|---|---|
| 1 | Donor film manufacturer (donor entity) develops LITI patterning |
| | method for imager and donor film. |
| 2 | Donor film manufacturer produces stock roll. |
| 3 | Donor film manufacturer provides imager specifications to |
| | vendor A. |
| 4 | Donor film manufacturer purchases imager from vendor A. |
| 5 | Customer B (display panel entity) purchases imager from donor |
| | film manufacturer. |
| 6 | Customer B purchases stock roll from donor film manufacturer. |
| 7 | Customer B deposits transfer layer on donor film manufacturer |
| | stock roll. |
| 8 | Customer B patterns donor film on display backplane according |
| | to donor film manufacturer methods. |
| 9 | Customer B sells LITI patterned display. |

TABLE 4
Process Model D

| Step | Description |
|---|---|
| 1 | Donor film manufacturer (donor entity) develops LITI patterning |
| | method for imager and donor film. |
| 2 | Donor film manufacturer produces stock roll. |
| 3 | Donor film manufacturer sheets, inspects, and mounts stock |
| | roll into film frames. |
| 4 | Donor film manufacturer provides imager specifications to |
| | vendor A. |
| 5 | Donor film manufacturer purchases imager from vendor A. |
| 6 | Customer B (display panel entity) purchases imager from |
| | donor film manufacturer. |
| 7 | Customer B purchases stock roll frames from donor film |
| | manufacturer. |
| 8 | Customer B deposits transfer layer on donor film manufacturer |
| | stock roll frames. |
| 9 | Customer B patterns donor film on display backplane according to |
| | donor film manufacturer methods. |
| 10 | Customer B returns spent film frames to donor film manufacturer |
| | for a credit. |
| 11 | Customer B sells LITI patterned display. |

Patterning of Sensitive Materials

FIG. 2 is a diagram illustrating a business model 20 for providing donor film with instructions for a LITI process. In model 20, a donor entity 22 provides donor film 24 (step 28) and instructions 26 (step 30) to a display panel entity 32. The donor entity 22 can provide the donor film in many different forms such as, for example, as a roll good or in individual sheets. In order to help protect the donor film, the donor entity will typically package it into appropriate packaging for shipping and then deliver it via any way of shipping goods.

The donor entity 22 can provide the instructions 26 with the donor film 24 or separately such as in an electronic communication. The instructions can include any information relating to how to image the donor film provided to the display panel entity such as the following: a compatible material set; suitable backplanes; imaging conditions; a compatible imager; an imaging wavelength for each material; or other parameters. The instructions can also optionally include an indication of zones for imaging to identify the best or acceptable areas of the donor film for imaging. Such instructions can be embodied in an electronic format, for example, such as a computer-implemented data structure as conceptually illustrated in Table 5. The donor film area for each imaging zone can be designated in a number of ways. For example, it can relate to physical markings on the donor film or a linear distance measurement from a particular starting point.

TABLE 5
Imaging Zones

| Imaging Zone | Donor Film Area |
|---|---|
| 1 | area 1a-1b |
| 2 | area 2a-2b |
| . . . | |
| N | area Na-Nb |

The display panel entity 32 coats the donor film and makes a display element 34 using the coated donor film and instructions. The display panel entity uses an imager 36 to make the display element 34, and it can provide a purchase fee 42 or license fee 40 to an imager entity 38 for use of imager 36. The donor entity 22 can alternatively provide for the purchase of the imager 36 by display panel entity 32 (step 46). In response for use of the instructions 26, display panel entity 32 provides a license fee (step 44) to donor entity 22.

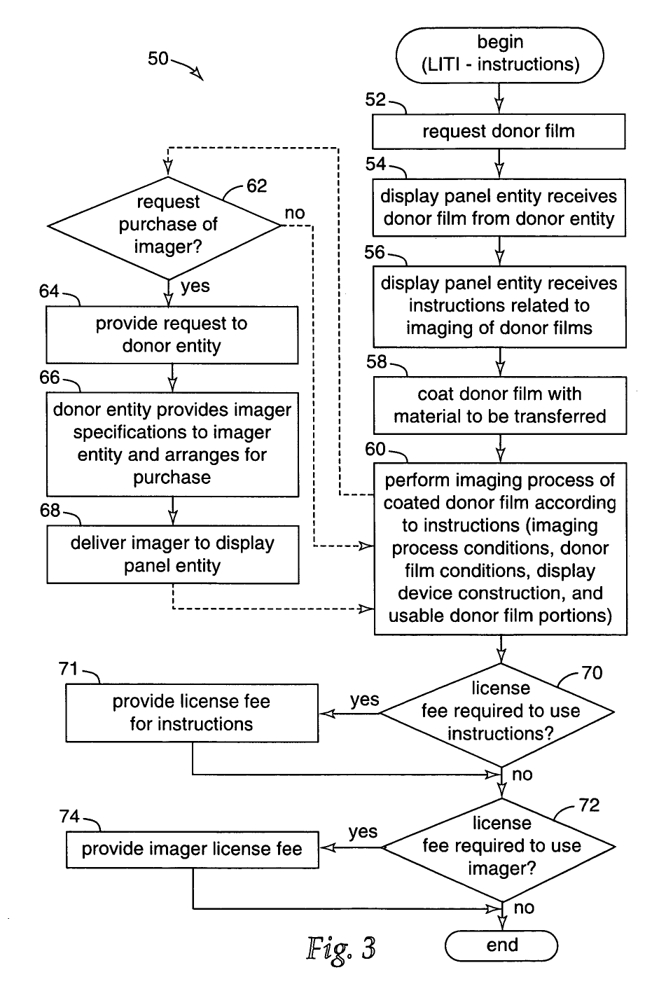

FIG. 3 is a flow chart of a method 50 for providing donor film with instructions for a LITI process in model 20. In method 50, a display panel entity makes a request for donor film (step 52) and receives the donor film from a donor entity (step 54). The display panel entity also receives instructions relating to how to pattern the received donor film (step 56), as indicated above. The display panel entity coats the donor film with a material to be transferred, typically an OLED or other material, to make a display element (step 58). Using the instructions, the display panel entity performs an imaging process of the coated donor film (step 60), which can include consideration of, for example, imaging process conditions, donor film conditions, display device construction, and usable donor film portions. If a license fee is required to use the instructions (step 70), the display panel entity provides a license fee to the donor entity (step 71). If a license fee is required to use the imager (step 72), the display panel entity provides an imager license fee to the donor entity (step 74). The license fee can be provided in any manner and include anything of monetary value.

As an ancillary method, the donor entity can receive a purchase request for an imager (step 62). If the display panel entity provides such as request (step 64), the donor entity provides imager specifications to the imager entity (step 66) and arranges for the purchase or licensing of the imager (step 66). The imager is then delivered to the display panel entity (step 68) for use in patterning coated donor film. The specifications relate to the requirements for the imager based upon, for example, the donor film construction and materials to be transferred.

The model and method shown in FIGS. 2 and 3 can be embodied, for example, in the form of legal relationships among the relevant parties, the donor entity, the display panel entity, and the imager entity. Also, the method shown in FIG. 3 can be implemented, for example, as a computerized process to monitor and track the delivery of donor film and instructions, the license fees, and the use of the imager.

Compatibility Techniques for Donor Recipients

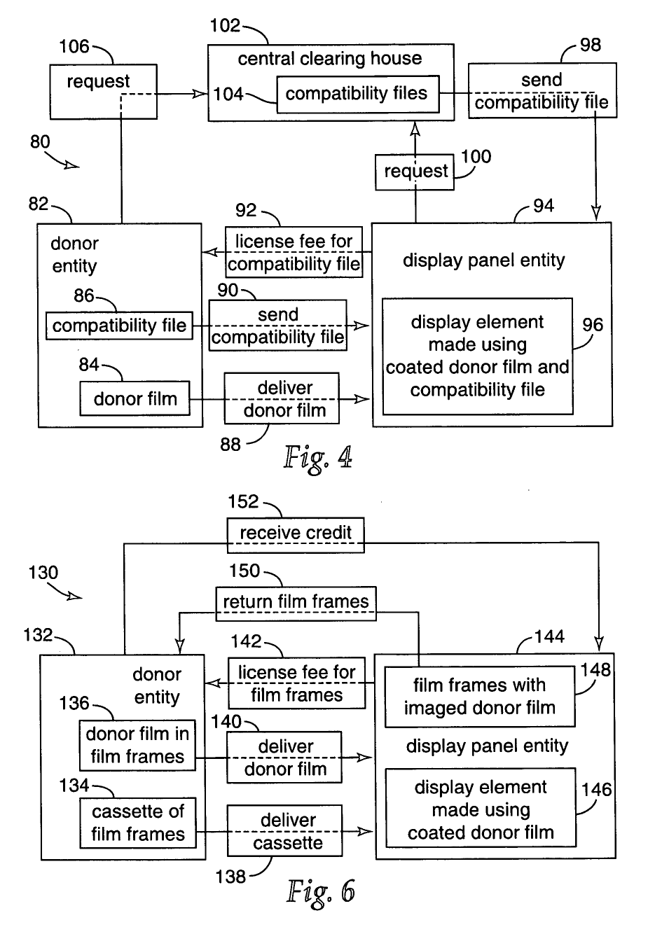

FIG. 4 is a diagram illustrating a business model 80 for providing donor film with a compatibility file for a LITI process. In model 80, a donor entity 82 provides donor film 84 (step 88) and a compatibility file 86 (step 90) to a display panel entity 94. The donor entity 82 can provide the donor film in many different forms such as, for example, as a roll good or in individual sheets. In order to help protect the donor film, the donor entity will typically package it into appropriate packaging for shipping and then deliver it via any way of shipping goods.

The donor entity 82 can provide the compatibility file 86 with the donor film 84 or separately such as in an electronic communication. A compatibility file provides an indication of a compatible LITI process that will provide for making a display element without a substantial impact upon its performance. For example, a compatibility file can provide an indication of a compatible material set, imager, and exposure parameters for a particular donor film construction. Table 6 provides an example of a conceptual structure for a compatibility file, which can be stored in a database or other data structure for association with particular donor film constructions.

TABLE 6
Compatibility File

| Donor Film Construction | Compatibility File |
|---|---|
| donor film 1 | material set 1 |
| | imager 1 |
| | exposure parameters 1 |
| . . . | |
| donor film N | material set N |
| | imager N |
| | exposure parameters N |

The display panel entity 94 coats the donor film and makes a display element 96 using the coated donor film and compatibility file. As an alternative model, the display panel entity 94 can request (step 100) a compatibility file from a central clearinghouse 102 storing multiple compatibility files 104. The donor entity 82 can also request (step 106) transfer of the compatibility file to the display panel entity 94. In response to requests 100 or 106, central clearinghouse 102 sends (step 98) the appropriate compatibility file to the display panel entity 94 such as via an electronic message. The donor entity 82 can receive a license fee (step 92) from the display panel entity 94 for use of the compatibility file.

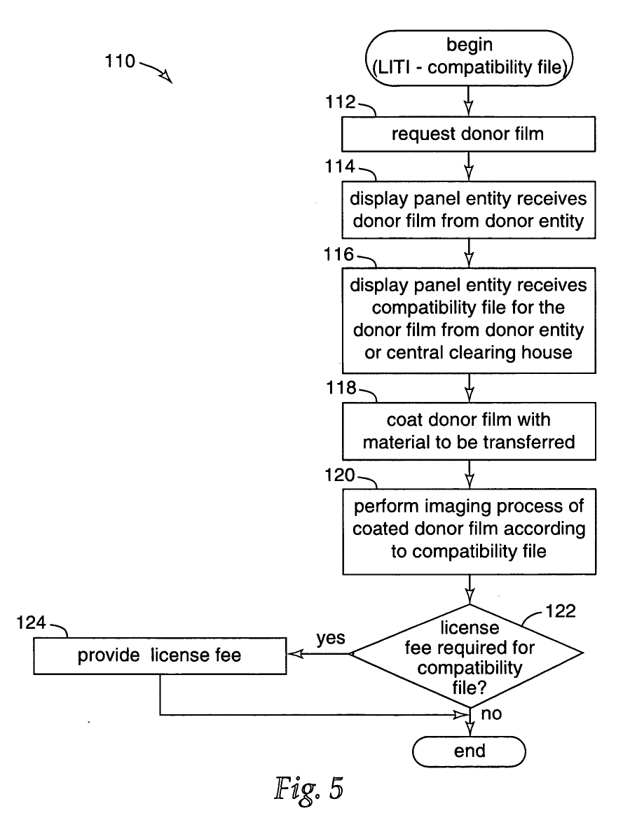

FIG. 5 is a flow chart of a method 110 for providing donor film with a compatibility file for a LITI process in model 80. In method 110, a display panel entity makes a request for donor film (step 112) and receives the donor film from a donor entity (step 114). The display panel entity also receives a compatibility file relating to compatible materials and imaging conditions for the donor film (step 116). Using the compatibility file, the display panel entity coats the donor film with a material to be transferred, typically an OLED or other material (step 118). The display panel entity also performs an imaging process of the coated donor film (step 120) according to the compatibility file to make a display element. If a license fee is required to use the compatibility file (step 122), the display panel entity provides a license fee to the donor entity (step 124). The license fee can be provided in any manner and include anything of monetary value.

The model and method shown in FIGS. 4 and 5 can be embodied, for example, in the form of legal relationships among the relevant parties, the donor entity, the display panel entity, and the central clearinghouse. Also, the method shown in FIG. 5 can be implemented, for example, as a computerized process to monitor and track the delivery of donor film and compatibility files, and the license fees.

Revenue Models

FIG. 6 is a diagram illustrating a business model 130 for providing donor film in film frames for a LITI process. In model 130, a donor entity 132 provides donor film 136 in film frames (step 140) to a display panel entity 144. Donor entity 132 can alternatively provide donor film in a cassette of film frames 134 to display panel entity 144 (step 138). In order to help protect the donor film, the donor entity 132 will typically package the film frames or cassette of frames into appropriate packaging for shipping and then deliver it via any way of shipping goods.

Film frames are particularly useful with cluster tools to manufacture display elements. A cluster tool includes several discrete but often interdependent processing chambers connected by a common transfer chamber. A robotic arm in the common transfer chamber moves items between the processing chambers to make a display element. The common transfer chamber is typically environmentally controlled; for example, it may be kept at a reduced pressure, a low moisture content, a low oxygen content, or under the environment of a specific gas. The use of film frames thus allows the robotic arm to move donor film into a processing chamber for imaging within a controlled environment. For example, after a first color is patterned, the robotic arm can retrieve the spent film frame and move it into another chamber. The robotic arm can then retrieve another film frame and repeat the process twice more to pattern red, green, and blue OLED materials to make a full color display element.

Using the donor film in film frames, display panel entity 144 coats the donor film and patterns it to make a display element 146, resulting in film frames with imaged donor film 148. The display panel entity 144 also provides a license fee (step 142) for use of the donor film in frames. Alternatively, if the display panel entity 144 returns the film frames after use of the donor film (step 150), it can receive a credit from donor entity 132 (step 152). Donor entity 132 can reuse the returned film frames to mount additional donor film for delivery and imaging.

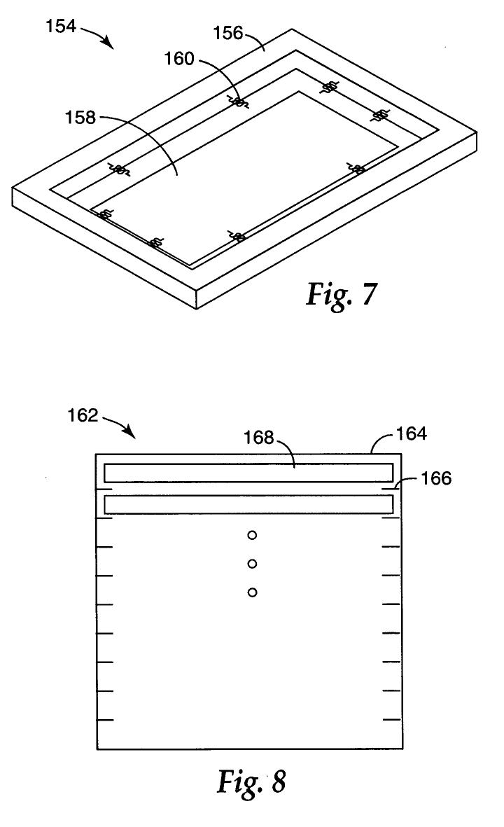

FIG. 7 is a diagram conceptually illustrating a donor film frame package 154, including a donor film 158 mounted in a film frame 156 and tensioned for patterning, for example using multiple springs and clips 160 or other tensioning devices. FIG. 8 is a diagram illustrating a cassette 162 of film frames having donor film mounted in them, such as film frame 168 in a housing 164 and positioned on a shelf 166. Film frames can include any way to mount and tension donor film for imaging.

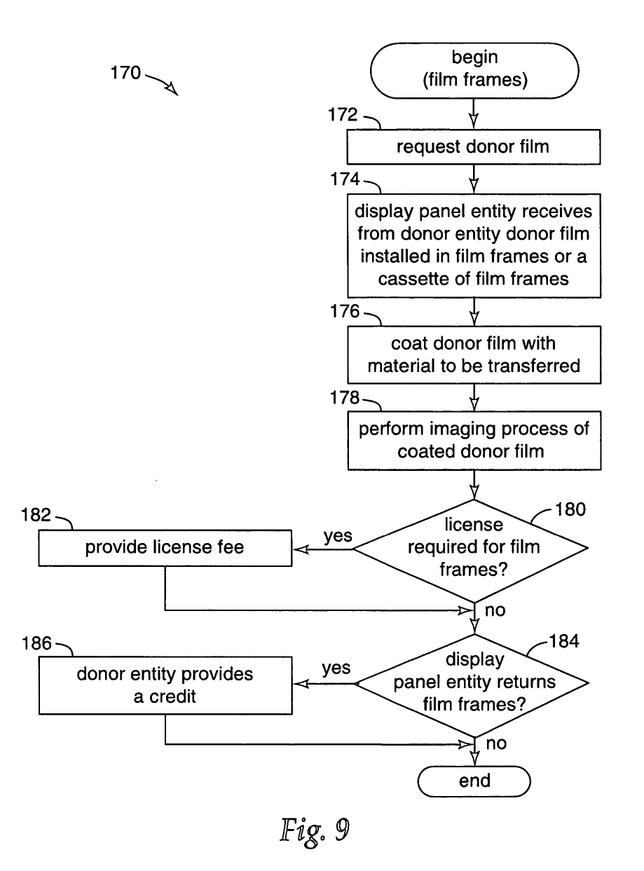

FIG. 9 is a flow chart of a method 170 for providing donor film in film frames for a LITI process in model 130. In method 170, a display panel entity requests donor film (step 172) and receives from a donor entity donor film installed in film frames or a cassette of film frames (step 174). The display panel entity coats the donor film with material to be transferred (step 176) and performs an imaging process of the coated donor film to make a display element (step 178). If a license is required for the film frames (step 180), the display panel entity provides a license fee (step 182). The license fee can be provided in any manner and include anything of monetary value. If the display panel entity returns the film frames (step 184), the donor entity provides a credit for the returned film frames (step 186). The credit can include anything of monetary value provided back to the display panel entity.

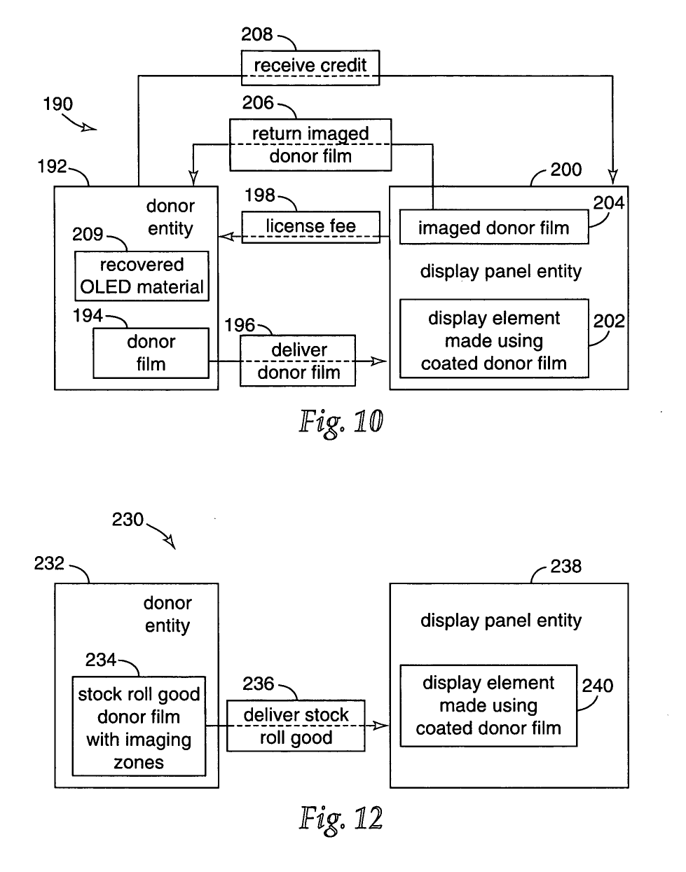

FIG. 10 is a diagram illustrating a business model 190 for providing and licensing the use of donor film for a LITI process. In model 190, a donor entity 192 provides donor film 194 (step 196) to a display panel entity 200. The donor entity 192 can provide the donor film in many different forms such as, for example, as a roll good or in individual sheets. In order to help protect the donor film, the donor entity will typically package it into appropriate packaging for shipping and then deliver it via any way of shipping goods.

The display panel entity 200 coats the donor film and makes a display element 202 using the coated donor film, the byproduct of which is imaged donor film 204. The display panel entity provides a license fee (step 198) to the donor entity for use of the donor film. It can return the imaged donor film (step 206) and receive a credit (step 208) for return of the imaged film. The donor entity 192 can then recover for reuse at least part of the OLED material 209 not transferred from the imaged donor film. Various techniques are available to recover unused OLED or other material from imaged donor film.

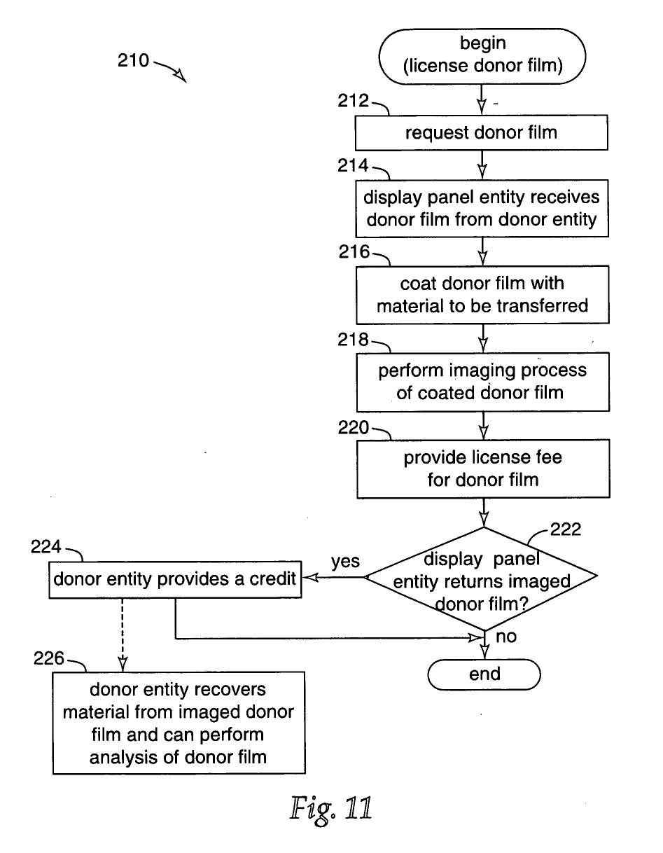

FIG. 11 is a flow chart of a method 210 for providing and licensing the use of donor film for a LITI process in model 190. In method 210, a display panel entity requests donor film (step 212) and receives donor film from a donor entity (step 214). The display panel entity coats the donor film with material to be transferred (step 216) and performs an imaging process of the coated donor film to make a display element (step 218). A license fee is provided for use of the donor film (step 220). The license fee can be provided in any manner and include anything of monetary value. If the display panel entity returns the imaged donor film (step 222), the donor entity provides a credit (step 224), which can include anything of monetary value provided back to the display panel entity. In an ancillary process, the donor entity can recover at least part of the material not transferred from the donor film and also perform analysis of the imaged donor film to obtain feedback concerning its performance during the LITI process (step 226).

The donor manufacturer can optionally recover OLED material not imaged using a process to remove the material from the donor sheet and purify it. The recovered OLED material can then be resold to a display panel entity for use in making displays, for example, or it can be used for any other purpose. Tables 7 and 8 describe examples of two processes for recovering OLED material from imaged donor film. Alternatively, any other process can be used that recovers the OLED material in such a state that it can be reused.

TABLE 7
Example of a Recovery Method for Soluble Light
Emitting Polymers (LEPs) or Small Molecules

| Step | Description |
|---|---|
| 1 | Separate spent red, green, and blue donors. |
| 2 | Wash each set of donors with a solvent that dissolves the OLED |
| | material without disrupting the underlying donor layers |
| | (e.g., substrate, LTHC, and interlayer). Examples of typical |
| | solvents include toluene, xylenes, and mesitylene. |
| 3 | Collect and concentrate the wash solution to obtain a crude OLED |
| | material mass. |
| 4 | Purify the crude OLED material. A typical method of purification |
| | for polymers is repeated precipitation of the polymer from solution. |
| | Soluble OLED small molecules may be purified by liquid |
| | chromatography. |

TABLE 8
Example of a Recovery Method for Insoluble Small Molecules

| Step | Description |
|---|---|
| 1 | Separate spent red, green, and blue donors. |
| 2 | Shred each set of donors with a crosscut shredder and collect in |
| | a container suitable for media milling. |
| 3 | Add a suitable grinding medium (e.g., glass, ceramic, or zirconia |
| | beads). The diameter of the grinding medium should be |
| | significantly smaller than the average dimension of the shredded |
| | donor film pieces. Prior to use, the grinding material should be |
| | cleaned, washed, and freed of residual organic material by |
| | vacuum baking at high temperatures or other suitable methods. |
| 4 | Tumble the mixture until the friable OLED transfer layer is |
| | removed. |
| 5 | Separate the shredded donor film by sizing the mixture with an |
| | appropriate metal sieve. |
| 6 | Collect the grinding medium/OLED transfer layer mixture. |
| 7 | Separate the OLED material from the grinding medium by |
| | subliming the organic material under vacuum. |
| 8 | Purify the insoluble OLED material by zone sublimation. |

The models and methods shown in FIGS. 6, and 9-11 can be embodied, for example, in the form of legal relationships among the relevant parties, the donor entity and the display panel entity. Also, the methods shown in FIGS. 5 and 9 can be implemented, for example, as a computerized process to monitor and track the delivery of donor film, the return of film frames and imaged donor film, the license fees, and the credits.

Treatment of the Donor Film in Preparation for Imaging

FIG. 12 is a diagram illustrating a business model 230 for providing donor film as a stock roll good with imaging zones for a LITI process. In model 230, a donor entity 232 delivers to a display panel entity 238 (step 236) a stock roll good donor film 234 with imaging zones. In order to help protect the donor film, the donor entity 232 will typically package it as the stock roll good into appropriate packaging for shipping and then deliver it via any way of shipping goods. The display panel entity 238 makes a display element 240 using coated donor film from the stock roll good.

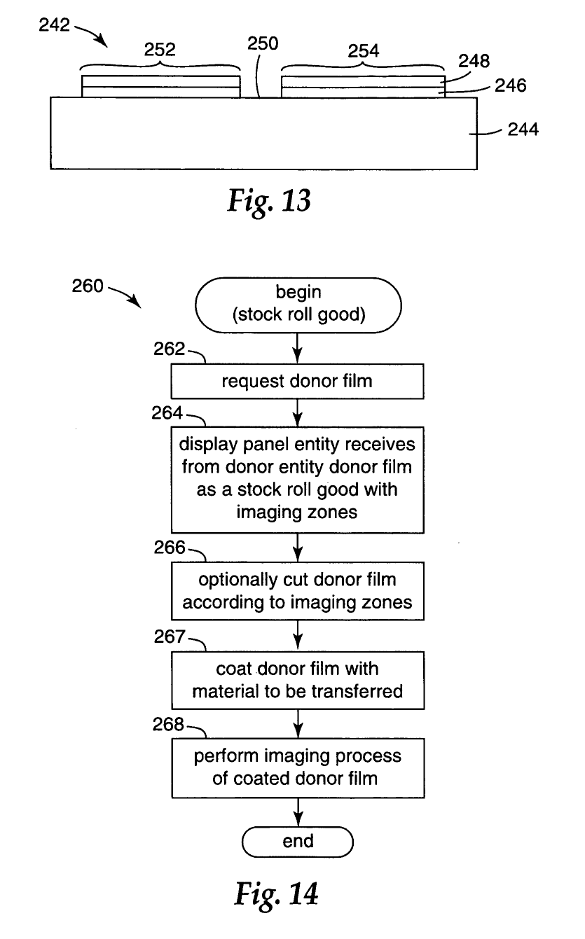

FIG. 13 is a diagram illustrating donor film 242 with imaging zones. Donor film 242 typically includes a substrate 244 and imaging zones 252 and 254. Each of the imaging zones typically includes a section of an LTHC 246 and optional interlayer 248. An optional cut zone 250 does not include the LTHC or interlayer, and it can represent an area where a display panel entity can conveniently cut the donor film for imaging of the individual imaging zones. These donor film cut zones can have the advantage of allowing for physical sectioning of the donor film without having to cut through the LTHC or optional interlayer, which can reduce an amount of debris resulting from the cutting. The cut zones can be identified with physical markings on the donor film or, if the donor film has an opaque LTHC, the cut zone will be readily apparent upon a visual inspection to identify substantially clear areas not having the LTHC.

FIG. 14 is a flow chart of a method 260 for providing donor film as a stock roll good for a LITI process in model 230. In method 260, a display panel entity requests donor film (step 262) and receives from a donor entity donor film as a stock roll good with imaging zones (step 264). The display panel entity optionally cuts the donor film for imaging according to the imaging zones (step 266). It coats the donor film with a material to be transferred (step 267) and performs an imaging process of the coated donor film (step 268).

The model and method shown in FIGS. 12 and 14 can be embodied, for example, in the form of legal relationships among the relevant parties, the donor entity and the display panel entity. Also, the method shown in FIG. 14 can be implemented, for example, as a computerized process to monitor and track the delivery of donor film with imaging zones.

Donor Manufacturing and Imaging Facilities

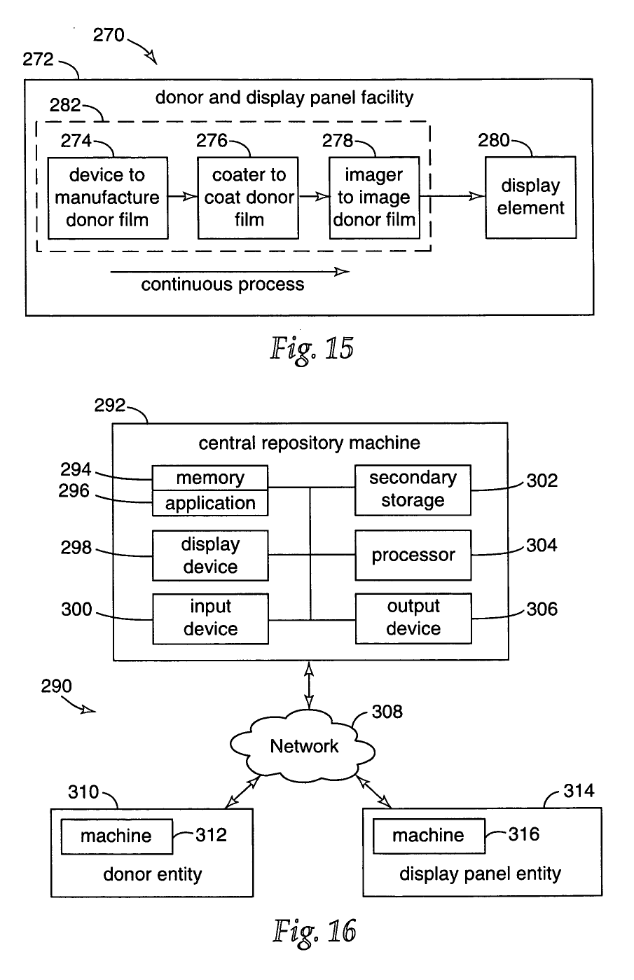

FIG. 15 is a diagram illustrating a business model 270 for manufacturing donor film and imaging it using LITI to make a display element in a facility as a single continuous process. In model 270, a single physical facility 272 includes, as a single process 282, a device 274 to manufacture donor film, a coater 276 to coat the donor film, and an imager 278 to image the donor film. The result of continuous process 282 is a display element 280.

Clearinghouse with Central Repository

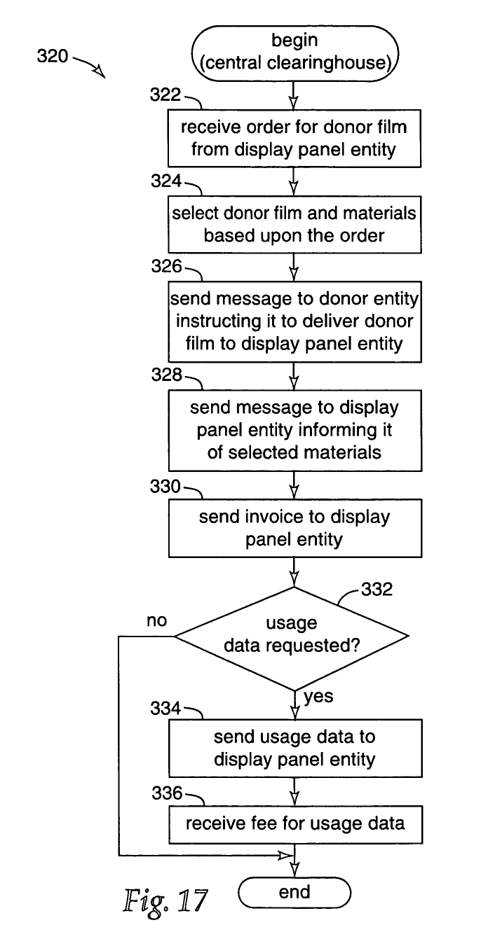

FIG. 16 is a diagram illustrating a system 290 for providing a central repository as a clearinghouse to arrange for the delivery of donor film for a LITI process. Model 290 includes central repository machine 292 connected, via a network 308, with a machine 312 in a donor entity 310 and with a machine 316 in a display panel entity 314. Central repository machine 292 includes, for example, a memory 294 storing one or more applications 296, a secondary storage 302 for providing non-volatile storage of data, a display device 298 for providing a visual indication of information, a processor 304 for executing applications, an input device 300 for receiving information or commands, and an output device 306 for outputting information such as in audio or hard copy form. Central repository machine 292 stores an identification of materials for imaging, an identification of constructions of donor film, and compatibility data providing an indication of which of the materials are compatible for an imaging process with which of the donor film constructions. This information can be stored in a data structure as conceptually illustrated in Table 6.

Machines 312 and 316 can include the same or similar components as machine 292. The machines 292, 312, and 316 can communicate via network 308 using any protocol for electronic network communication, such as Transmission Control Protocol/Internet Protocol (TCP/IP).

FIG. 17 is a flow chart of a method 320 for providing a central repository as a clearinghouse to arrange for the delivery of donor film for a LITI process using system 290. In method 320, central repository 292 receives an order for donor film from display panel entity 314 (step 322). Based upon the order, central repository 292 selects a donor film and materials (step 324). Central repository 292 sends a message to donor entity 310 instructing it to deliver the ordered donor film to display panel entity 310 (step 326), and it sends a message to display panel entity 314 informing it of the selected materials for imaging using the ordered donor film (step 328). The donor entity can provide the donor film in many different forms such as, for example, as a roll good or in individual sheets. In order to help protect the donor film, the donor entity will typically package it into appropriate packaging for shipping and then deliver it via any way of shipping goods.

Central repository 292 can also send an invoice to display panel entity 314 for the delivered donor film (step 330). If display panel entity had also requested usage data relating to imaging of the delivered donor film (step 332), central repository 292 sends usage data to display panel entity 314 (step 334) and receives a fee for the usage data (step 336). The usage data can be provided with the donor film or separately such as in an electronic message. Usage data can include the instructions or compatibility file, as described above, or a combination of the instructions and compatibility file or a subset of that combined information.

While the present invention has been described in connection with an exemplary embodiment, it will be understood that many modifications will be readily apparent to those skilled in the art, and this application is intended to cover any adaptations or variations thereof. For example, various types of materials and constructions of the donor film, and models for implementing LITI, may be used without departing from the scope of the invention. This invention should be limited only by the claims and equivalents thereof.

1. A method for laser induced thermal imaging using associated instructions, comprising:
receiving by a first entity a donor film, the donor film comprising a substrate and a light-to-heat conversion layer on the substrate, wherein the donor film is manufactured by a second entity and delivered to the first entity;
receiving instructions indicating how to coat and transfer materials using the donor film according to an imaging process; and
coating the materials as a transfer layer on the light-to-heat conversion layer of the donor film and performing imaging process, according to the instructions, for manufacture of a display element.

2. The method of claim 1, wherein the receiving the instructions step includes receiving the instructions indicating how to perform the imaging process based upon imaging process conditions related to the donor film, conditions of the donor film, and a construction of a display element to be made at least in part by the imaging process.

3. The method of claim 1, further comprising determining usable portions of the donor film for the imaging process based upon the instructions.

4. The method of claim 1, further comprising licensing use of the instructions for the imaging process and providing a fee for the licensing.

5. The method of claim 1, further comprising purchasing an imager capable of performing the imaging process by the first entity, wherein the second entity arranges for the purchase of the imager.

6. The method of claim 1, further comprising licensing use of an imager capable of performing the imaging process by the second entity.

7. A method for laser induced thermal imaging using an associated compatibility file, comprising:
receiving by a first entity a donor film, the donor film comprising a substrate and a light-to-heat conversion layer on the substrate, wherein the donor film is manufactured by a second entity and delivered to the first entity;
receiving a compatibility file certifying the compatibility of particular materials to be transferred with particular constructions of the donor film for an imaging process;
selecting materials and selected a particular construction of the donor film according to the compatibility file; and
coating the selected materials as a transfer layer on selected construction of the donor film and performing the imaging process for manufacture of a display element.

8. The method of claim 7, further comprising receiving from a central clearinghouse, via a computerized method and based upon the compatibility file, shipment of the selected materials and the selected construction of the donor film.

9. The method of claim 7, further comprising licensing use of the compatibility file for performing the imaging process and providing a fee for the licensing.

10. A method for laser induced thermal imaging using film frames, comprising:
receiving by a first entity donor film installed in film frames, the donor film comprising a substrate and a light-to-heat conversion layer on the substrate, wherein a second entity manufactures the donor film, installs the donor film in the film frames, and delivers to the first entity the film frames with the installed donor film;
applying a material to the donor film in the film frames and performing an imaging process for the donor film while in the film frames for manufacture of a display element; and
licensing use of the film frames for the imaging process with the installed donor film and providing a fee for the licensing.

11. The method of claim 10, further comprising returning to the second entity the film frames following the imaging process and receiving a credit, applied to the fee for the licensing, for the return of the film frames.

12. The method of claim 10, further including receiving a cassette of the film frames with the installed donor film.

13. A method for laser induced thermal imaging by licensing the use of donor film, comprising:
receiving by a first entity a donor film, the donor film comprising a substrate and a light-to-heat conversion layer on the substrate, wherein the donor film is manufactured by a second entity and delivered to the first entity;
coating a material on the donor film and performing an imaging process of the coated donor film for use in manufacturing a display element;
licensing the second entity to use the donor film for the imaging process;
returning the imaged donor film after the imaging process; and
receiving a credit from the second entity for return of the imaged donor film.

14. A method for laser induced thermal imaging using a donor film stock roll good, comprising:
receiving by a first entity donor film installed in film frames, the donor film comprising a substrate and a light-to-heat conversion layer on the substrate, wherein a second entity manufactures the donor film as a stock roll good, provides within the stock roll good imaging zones dividing portions of the stock roll good donor film intended for an imaging process of the donor film, and delivers to the first entity the stock roll good donor film;
applying a material to the donor film based upon the imaging zones; and
performing an imaging process of the donor film based upon the imaging zones for use in manufacturing a display element.

15. The method of claim 14, wherein the receiving step includes receiving the stock roll good donor film having cut zones not including the light-to-heat conversion layer.

16. A method for laser induced thermal imaging using a continuous process, comprising:
manufacturing donor film, the donor film comprising a substrate and a light-to-heat conversion layer on the substrate;
coating the donor film with a material to be imaged; and
imaging the donor film with the material for use in manufacturing a display element,
wherein the manufacturing, coating, and imaging steps occur in a facility as a single continuous process.

17. A computerized method for providing a central clearinghouse for laser induced thermal imaging, comprising:
electronically storing in a central repository an identification of materials for imaging, an identification of constructions of donor film, and compatibility data providing an indication of which of the materials are compatible for an imaging process with which of the donor film constructions;
receiving an order for donor film from an entity;
selecting at least one of the materials and at least one of the donor film constructions based upon the order and the compatibility data;
electronically arranging for delivery of the selected donor film to the entity; and
electronically sending a message to the entity providing an indication of the selected materials.

18. The method of claim 17, further comprising electronically sending an invoice to the entity for the delivery of the donor film.

19. The method of claim 17, further comprising storing in the central repository usage data providing an indication of portions of the particular donor film constructions usable for the imaging process.

20. The method of claim 19, further comprising:
electronically sending the usage data to the entity; and
receiving a fee for the usage data.
